(19) United States
(12) Patent Application Publication
(10) Pub. No.: US 2015/0154032 A1
(43) Pub. Date: Jun. 4, 2015

(54) SERVER BOOTSTRAPPING METHOD AND COMPUTER SYSTEM

(71) Applicants: INVENTEC CORPORATION, Taipei City (TW); INVENTEC (PUDONG) TECHNOLOGY CORPORATION, Shanghai (CN)

(72) Inventors: YU-XI CHEN, Shanghai City (CN); WEI HUANG, Shanghai City (CN)

(73) Assignees: INVENTEC CORPORATION, Taipei City (TW); INVENTEC (PUDONG) TECHNOLOGY CORPORATION, Shanghai (CN)

(21) Appl. No.: 14/220,552

(22) Filed: Mar. 20, 2014

(30) Foreign Application Priority Data
Nov. 29, 2013 (CN) 201310630316.4

(51) Int. Cl. G06F 9/44

(52) U.S. Cl. CPC G06F 9/4408

(57) ABSTRACT

Disclosed herein is a server bootstrapping method for loading an operating system for a server where storage devices bijectively correspond to ports. The basic input/output system (BIOS) of the server scans the storage devices to generate a boot hardware information table and determines whether a port-fixed bootstrapping function is enabled. If the function is enabled, the BIOS, using a preset port address sequence, generates boot sequence numbers, writes them into the boot hardware information table, and checks the storage devices according to them, until the operating system is loaded from one of the storage devices.

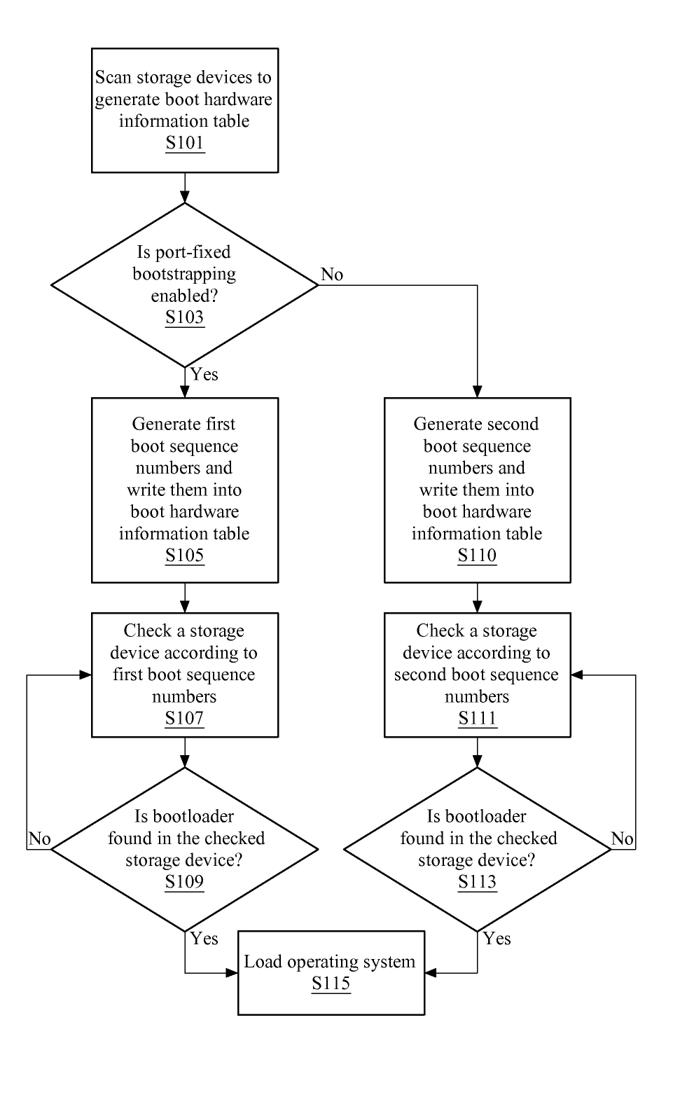

### CROSS REFERENCE TO RELATED APPLICATIONS

This non-provisional application claims priority under 35 U.S.C. §119(a) on Patent Application No. 201310630316.4 filed in People's Republic of China on Nov. 29, 2013, the entire contents of which are hereby incorporated by reference.

### TECHNICAL FIELD

The present invention relates to server technology, particularly to a server bootstrapping method and a computer system implementing the method.

### BACKGROUND

Hard disk drives (HDDs) capable of storing bulk data are among the most important components in computers. The uninterrupted operation of, say, a storage node in a data center depends on whether the hundreds of HDDs connected to the node can be effectively managed. Poor management results in the node frequently crashing, or worse still, evaporation of data. A broken HDD is often the culprit behind inaccessible operating systems or inadvertently altered boot device sequences. Suppose that, upon leaving the factory, a server had three HDDs D0, D1, and D2 respectively attached to three ports P0, P1, and P2. By convention, the server's operating system was installed on the HDD D0, the ideal boot device sequence being ‘D0, D1, D2’. At a later time the HDD D0 broke down and was removed. D0 is thus skipped in the boot device sequence, which has now become ‘D1, D2’. The boot device sequence will be ‘D1, D2, D3’ when a new or repaired HDD D3 is inserted back to the port P0. That the HDD D1 is chosen as the residence of a re-installed operating system not only risks damaging the data originally stored therein, but also violates the practice of bootstrapping with the HDD at the port P0.

### SUMMARY

In light of the above, the present invention discloses a server bootstrapping method and a computer system implementing the method, where the boot device sequence is unambiguously and conveniently fixed based on port addresses.

The server bootstrapping method provided by this disclosure loads an operating system for a server which has storage devices and ports. The storage devices, bijectively corresponding to the ports, are first scanned so that a boot hardware information table recording information items of the storage devices and addresses of the ports is generated. Next, the method determines whether a port-fixed bootstrapping function is enabled in the server.

If such function is enabled, first boot sequence numbers bijectively corresponding to the storage devices are generated based on a preset port address sequence and then written into the boot hardware information table. The storage devices are checked on by one according to the first boot sequence numbers based on the boot hardware information table until the operating system is loaded from one of them. When one of the storage devices is replaced with a new storage device which corresponds to the port corresponding to the replaced storage device, the new storage device is made to correspond to the first boot sequence number corresponding to the replaced storage device.

If, however, port-fixed bootstrapping is not enabled, second boot sequence numbers bijectively corresponding to the storage devices are generated based on the information items and then written into the boot hardware information table. The storage devices are checked on by one according to the second boot sequence numbers based on the boot hardware information table until the operating system is loaded from one of them. When one of the storage devices is replaced with a new storage device, the new storage device is made to correspond to a new boot sequence number which is in succession to the second boot sequence numbers.

The computer system provided by this disclosure comprises ports for transmitting data, storage devices bijectively corresponding to the ports, and a basic input/output system (BIOS). The BIOS is adapted for communicating with the ports, scanning the storage devices to generate a boot hardware information sequence which records information items of the storage devices and addresses of the ports, and determining whether a port-fixed bootstrapping function is enabled.

If such function is enabled, the BIOS is further adapted for generating first boot sequence numbers bijectively corresponding to the storage devices based on a preset port address sequence, for writing the first boot sequence numbers into the boot hardware information table, and for checking one by one the storage devices according to the first boot sequence numbers based on the boot hardware information table until the operating system is loaded from one of the storage devices. When one of the storage devices is replaced with a new storage device which corresponds to the port corresponding to the replaced storage device, the BIOS makes the new storage device correspond to the first boot sequence number corresponding to the replaced storage device.

If, however, port-fixed bootstrapping is not enabled, the BIOS is further adapted for generating second boot sequence numbers bijectively corresponding to the storage devices based on the information items, for writing the second boot sequence numbers into the boot hardware information table, and for checking one by one the storage devices according to the second boot sequence numbers based on the boot hardware information table until the operating system is loaded from one of the storage devices. When one of the storage devices is replaced with a new storage device, the BIOS makes the new storage device correspond to a new boot sequence number which is in succession to the second boot sequence numbers.

In short, by recognizing the storage devices using the ports they are connected to, operating systems will no longer be inaccessible, nor boot device sequences altered, after the attachment or detachment of any of the storage devices, since in the server the port addresses are always fixed. In one embodiment, the storage devices are sorted based on their classification in addition to the addresses, a higher-level management of boot devices that is both effective and logical.

### BRIEF DESCRIPTION OF THE DRAWING

The present invention will become more fully understood from the detailed description given hereinbelow and the accompanying FIGURE. The FIGURE, given by way of illustration only and thus is not limitative of the present invention, is a flowchart of a server bootstrapping method, in accordance with one embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Please refer to the sole accompanying FIGURE. The flowchart illustrates an embodiment of a server bootstrapping method performed by a basic input/output system (BIOS) of a server or a computer system having storage devices. The storage devices may be various kinds of hard disk drives (HDDs), each connected to the server via an interface like SATA (Serial Advanced Technology Attachment) or SAS (Serial Attached SCSI, SCSI itself an acronym of Small Computer System Interface), or through a RAID (redundant array of independent disks) expansion card. As shown in the FIGURE, in step S101 the BIOS scans the storage devices to generate a boot hardware information table (hereafter referred to as the table) recording an information item of each storage device and the address of the port to which each is connected. Generally speaking, the operation of the BIOS involves the central processing unit (CPU) and a dedicated read-only memory of the server, the latter storing the machine code that the CPU first reads according to its program counter when the server is powered on. By executing this machine code, the CPU is bestowed with the capabilities of the BIOS, e.g. carrying out the power-on self-test (POST), which includes initializing the swarm of components in the server and collecting information of the components.

The BIOS determines whether a port-fixed bootstrapping function is enabled in step S103; in other words, there may be an option related to such function in the BIOS setup menu, where it can be enabled or disabled. If the function is enabled, then in step S105 the BIOS generates first boot sequence numbers (hereafter referred to as BSNs) based on a preset port address sequence. The first BSNs, bijectively corresponding to the storage devices, are then written into the table by the BIOS. Please note that if a storage device at a certain port is replaced with a new one, its corresponding first BSN is inherited by the new storage device. Consider the example of HDDs D1, D2, and D3 respectively located at ports P1, P2, and P0. The HDD D3 is a replacement for the damaged HDD D0, which was connected to the port P0. Sorting the HDDs based on the port addresses yields ‘D3, D1, D2’, because the HDD D3 is at the foremost numbered port.

In one embodiment, the storage devices are divided into several categories, while a user or a factory default of the server may assert that one such category takes precedence over another in the boot device sequence. For instance, assume that the ports P1, P2, and P0 are SATA ports, and HDDs D4 and D5 connect to the server respectively at SAS ports Q0 and Q1. Further assume that the BIOS shall consider SATA-connected HDDs before SAS-connected ones. The sequence for the HDDs on SATA is ‘D3, D1, D2’, whereas that for those SAS is ‘D4, D5’. Combining the two sequences yields ‘D3, D1, D2, D4, D5’.

Next, the BIOS checks one by one the storage devices according to the first BSNs in the table until an operating system can be loaded from one of them. In particular, the BIOS looks at one of the storage devices based on the first BSNs in step S107, in order to determine in step S109 whether a bootloader of an operating system is stored in that storage device. The BIOS usually selects the storage device corresponding to the first of the first BSNs and makes a decision. If the bootloader is found, the BIOS executes it in step S115 and relinquishes control of the CPU; if not, the BIOS returns to step S107 and checks the storage device corresponding to the next first BSN. Continuing with the above example, the BIOS would check the HDD D2 next if neither the HDD D3 nor the HDD D1 possessed the bootloader. After the removal of the HDD D0 and before the installation of the HDD D3, in one embodiment, the table still lists the port P0, but only with a null corresponding information item, prompting the BIOS to send out an alert when it is not able to find the HDD D0 or any storage device based on the first BSNs.

In one embodiment, the table obtained in step S101 further includes the inherent sequence of installation of the storage devices. Continuing with the above example, suppose that the HDDs D1, D2, D4, and D5 have never been detached, while the HDD D0 originally connected to the port P0 is broken and replaced with the HDD D3. The sequence of installation is thus ‘D1, D2, D4, D5, D3’; in other words, if the storage device at a port is replaced with a new one, the BSN corresponding to the new storage device is appended to the tail of second BSNs. When it is determined in step S103 that port-fixed bootstrapping is disabled, the BIOS generates the second BSNs based on the sequence of installation. The second BSNs, bijectively corresponding to the storage devices, are then written into the table by the BIOS. Next, the BIOS checks one by one the storage devices according to the second BSNs in the table until an operating system can be loaded from one of them. In particular, the BIOS looks at one of the storage devices based on the second BSNs in step S111, in order to determine in step S113 whether a bootloader of an operating system is stored in that storage device. The procedure of steps S111, S113, and S115 is similar to that of steps S107, S109, and S115.

To summarize, by recognizing the storage devices using the ports they are connected to, operating systems will no longer be inaccessible, nor boot device sequences altered, after the attachment or detachment of any of the storage devices, since in the server the port addresses are always fixed. In one embodiment, options exist so that the storage devices can be sorted based on the port address sequence or the sequence of installation. In another embodiment, the storage devices are categorized and sorted, a multi-layered management of boot devices that is both effective and logical.

What is claimed is:

1. A server bootstrapping method for loading an operating system for a server which has storage devices and ports, the storage devices bijectively corresponding to the ports, the server bootstrapping method comprising:
scanning the storage devices to generate a boot hardware information table which records information items of the storage devices and addresses of the ports; and
determining whether a port-fixed bootstrapping function is enabled;
wherein if the function is enabled, the following steps are performed:
generating first boot sequence numbers based on a port address sequence which is preset, the first boot sequence numbers bijectively corresponding to the storage devices;
writing the first boot sequence numbers into the boot hardware information table; and
checking one by one the storage devices according to the first boot sequence numbers based on the boot hardware information table until the operating system is loaded from one of the storage devices;
wherein when one of the storage devices is replaced with a new storage device which corresponds to the port corresponding to the replaced storage device, the new storage device is made to correspond to the first boot sequence number corresponding to the replaced storage device;
wherein if the function is not enabled, the following steps are performed:
generating second boot sequence numbers based on the information items, the second boot sequence numbers bijectively corresponding to the storage devices;
writing the second boot sequence numbers into the boot hardware information table; and
checking one by one the storage devices according to the second boot sequence numbers based on the boot hardware information table until the operating system is loaded from one of the storage devices;
wherein when one of the storage devices is replaced with a new storage device, the new storage device is made to correspond to a new boot sequence number which is in succession to the second boot sequence numbers.

2. The server bootstrapping method of claim 1, wherein the ports bijectively correspond to the addresses, the storage devices bijectively correspond to the information items, the information items bijectively correspond to the addresses, and when the function is enabled and one of the storage devices is removed, in the boot hardware information table the information item corresponding to the address which corresponds to the port corresponding to the removed storage device is made null but the first boot sequence number corresponding to the removed storage device is kept, and checking the storage devices according to the first boot sequence numbers comprises:
sending an alert when the information item corresponding to the storage device which corresponds to one of the first boot sequence numbers is null.

3. The server bootstrapping method of claim 1, wherein the information items include models, types, and a sequence of installation of the storage devices.

4. The server bootstrapping method of claim 1, wherein the storage devices are at least divided into a first category and a second category, the ports bijectively correspond to the addresses, and generating the first boot sequence numbers based on the port address sequence comprises:
sorting the storage devices of the first category to obtain a first sequence, based on the addresses corresponding to the ports which correspond to the storage devices of the first category;
sorting the storage devices of the second category to obtain a second sequence, based on the addresses corresponding to the ports which correspond to the storage devices of the second category; and
forming the port address sequence based on the first sequence, the second sequence, and a category sequence which dictates that the first sequence takes precedence over the second sequence in the port address sequence.

5. The server bootstrapping method of claim 4, wherein the storage devices of the first category or the second category are hard disk drives, each of which connected to the server at a SATA (Serial Advanced Technology Attachment) or SAS (Serial Attached SCSI) port or through a RAID (redundant array of independent disks) expansion card.

6. A computer system comprising:
ports for transmitting data;
storage devices bijectively corresponding to the ports; and
a basic input/output system (BIOS) for communicating with the ports, scanning the storage devices to generate a boot hardware information sequence which records information items of the storage devices and addresses of the ports, and determining whether a port-fixed bootstrapping function is enabled;
wherein if the function is enabled, the BIOS is further adapted for generating first boot sequence numbers based on a port address sequence which is preset, the first boot sequence numbers bijectively corresponding to the storage devices, for writing the first boot sequence numbers into the boot hardware information table, and for checking one by one the storage devices according to the first boot sequence numbers based on the boot hardware information table until the operating system is loaded from one of the storage devices, and when one of the storage devices is replaced with a new storage device which corresponds to the port corresponding to the replaced storage device, the BIOS makes the new storage device correspond to the first boot sequence number corresponding to the replaced storage device;
wherein if the function is not enabled, the BIOS is further adapted for generating second boot sequence numbers based on the information items, the second boot sequence numbers bijectively corresponding to the storage devices, for writing the second boot sequence numbers into the boot hardware information table, and for checking one by one the storage devices according to the second boot sequence numbers based on the boot hardware information table until the operating system is loaded from one of the storage devices, and when one of the storage devices is replaced with a new storage device, the BIOS makes the new storage device correspond to a new boot sequence number which is in succession to the second boot sequence numbers.

7. The computer system of claim 6, wherein the ports bijectively correspond to the addresses, the storage devices bijectively correspond to the information items, the information items bijectively correspond to the addresses, and when the function is enabled and one of the storage devices is removed, in the boot hardware information table the information item corresponding to the address which corresponds to the port corresponding to the removed storage device is made null but the first boot sequence number corresponding to the removed storage device is kept by the BIOS, and when the BIOS checks the storage devices according to the first boot sequence numbers, the BIOS sends an alert when the information item corresponding to the storage device which corresponds to one of the first boot sequence numbers is null.

8. The computer system of claim 6, wherein the information items include models, types, and a sequence of installation of the storage devices.

9. The computer system of claim 6, wherein the storage devices are at least divided into a first category and a second category, the ports bijectively correspond to the addresses, and when the BIOS generates the first boot sequence numbers based on the port address sequence, the BIOS sorts the storage devices of the first category to obtain a first sequence, based on the addresses corresponding to the ports which correspond to the storage devices of the first category, sorts the storage devices of the second category to obtain a second sequence, based on the addresses corresponding to the ports which correspond to the storage devices of the second category, and forms the port address sequence based on the first sequence, the second sequence, and a category sequence which dictates that the first sequence takes precedence over the second sequence in the port address sequence.

10. The computer system of claim 9, wherein the storage devices of the first category or the second category are hard disk drives, each of which connected to the server at a SATA (Serial Advanced Technology Attachment) or SAS (Serial Attached SCSI) port or through a RAID (redundant array of independent disks) expansion card.
